(19) United States
(12) Patent Application Publication
(10) Pub. No.: US 2014/0085455 A1
(43) Pub. Date: Mar. 27, 2014

(54) NUMERICAL CONTROLLER HAVING FUNCTION OF MANIPULATING VIDEO CAMERA BY USING G-CODE COMMAND

(71) Applicant: FANUC Corporation, Minamitsuru-gun (JP)

(72) Inventors: Mamoru KUBO, Minamitsuru-gun (JP); Shuuzou ADACHI, Minamitsuru-gun (JP)

(73) Assignee: FANUC Corporation, Minamitsuru-gun (JP)

(21) Appl. No.: 14/031,679

(22) Filed: Sep. 19, 2013

(30) Foreign Application Priority Data
Sep. 24, 2012 (JP) 2012-209429

(51) Int. Cl. H04N 5/232

(52) U.S. Cl. CPC H04N 5/23203
USPC 348/86

(57) ABSTRACT

A video camera which shoots a machine tool is connected to a numerical controller which controls the machine tool. The numerical controller has a function of manipulating the video camera by using a G-code command that is a preparatory function included as standard in the numerical controller. The numerical controller can give a command to the video camera by one block of a machining program. Additionally, a G-code can be commonly used in all machine tools equipped with same numerical controllers.

### BACKGROUND OF THE INVENTION

1. Field of the Invention

The present invention relates to a numerical controller having a function of manipulating a video camera connected to a machine tool.

2. Description of the Related Art

The use of images shot by video cameras attached to a machine tool, a peripheral device, and the like for remote monitoring of a workpiece to be machined and a peripheral device, quality control through recording of an image or a video of a machined workpiece, and the like has increased in recent years.

Japanese Patent Application Laid-Open No. 2005-190102 discloses a technique for installing a video camera inside a machine tool which is controlled by a numerical controller and performing remote monitoring of a workpiece to be machined and a peripheral device and quality control by using images shot by the video camera and a technique for setting an image pickup parameter by using a table.

Japanese Patent Application Laid-Open No. 2012-18511 discloses a numerical controller for controlling a machine tool which includes a sequence processing section that processes an auxiliary command issued by a machining program, a built-in auxiliary command processing section that processes the auxiliary command without processing by the sequence processing section, and an auxiliary command switching section that switches whether an auxiliary command is to be processed by the sequence processing section or the auxiliary command processing section.

Japanese Patent Application Laid-Open No. 63-205707 discloses a numerical controller in which processing time for an auxiliary function is shortened by allowing advancement to processing of a next block only by a programmable machine controller (PMC) outputting a process completion signal, unlike a conventional method in which processing advances in a numerical controller while a PMC and a CPU for numerical control (NC) alternately confirm processing by the other side.

Japanese Patent Application Laid-Open No. 2012-18511 mentioned above discloses a technique for manipulating a video camera by initiating a ladder sequence by using an M-code command called an auxiliary function. It is thus conceivable to apply the technique to the idea of performing remote monitoring of a workpiece to be machined and a peripheral device and quality control by using shot images obtained by manipulating a video camera connected to a numerically controlled machine tool that is the technique described in Japanese Patent Application Laid-Open No. 2005-190102 mentioned above.

A concrete example of manipulation of a video camera by using M-code commands will be described with reference to FIGS. 10 to 13.

FIG. 10 is a chart showing the correspondence between M-code commands and manipulation command contents.

An M-code is an auxiliary command code for controlling the on/off status of peripheral equipment mounted to a numerically controlled machine tool and the like based on a machining program. For this reason, when a manipulation command is given by using an M-code command, one M-code command corresponds to one manipulation of a video camera e.g., M801 that is an M-code indicates image pickup (640×480) by a first video camera, and M800 indicates stopping of image pickup by the first video camera, as shown in FIG. 10.

FIG. 11 is an example of a machining program using the M-code commands shown in FIG. 10.

FIG. 12 is a flow chart showing a flow of manipulation of a video camera by using M-code commands. The flow will be described below along with the steps.

[Step SA1] It is first determined whether the condition that an auxiliary command completion signal is off and that an auxiliary command signal is on, i.e., the condition that processing is not completed and that an M-code signal has been inputted to turn on the auxiliary command signal is satisfied or not. If the result of the determination is YES, the process proceeds to step SA2. On the other hand, if the result is NO, the process proceeds to step SA14.

Steps SA2 to SA11 are routines which determine in turn whether respective commands are issued or not.

[Step SA2] It is determined whether an M801 command has been issued. If an M801 command has been issued (YES), the process proceeds to step SA3. Otherwise (NO), the process proceeds to step SA4.
[Step SA3] Video camera 1 is manipulated at a resolution of 640×480 in response to the M801 command.
[Step SA4] It is determined whether an M802 command has been issued or not. If an M802 command has been issued (YES), the process proceeds to step SA5. Otherwise (NO), the process proceeds to step SA6.
[Step SA5] Video camera 1 is manipulated at a resolution of 320×240 in response to the M802 command.
[Step SA6] It is determined whether an M803 command has been issued or not. If an M803 command has been issued (YES), the process proceeds to step SA7. Otherwise (NO), the process proceeds to step SA8.
[Step SA7] Video camera 1 is manipulated at a resolution of 160×120 in response to the M803 command.
[Step SA8] It is determined whether an M804 command has been issued or not. If an M804 command has been issued (YES), the process proceeds to step SA9. Otherwise (NO), the process proceeds to step SA10.
[Step SA9] A still image is shot with video camera 1 in response to the M804 command.
[Step SA10] It is determined whether an M800 command has been issued or not. If an M800 command has been issued (YES), the process proceeds to step SA11. Otherwise (NO), the process proceeds to step SA12.
[Step SA11] Image pickup by video camera 1 is stopped in response to the M800 command.
[Step SA12] As is the case for video camera 1, a sequence for a second video camera (video camera 2) corresponding to M-code commands (M810 to M814) is performed.

[Step SA13] The auxiliary command completion signal is turned on, and the process (the process of manipulating a video camera by using M-code commands) is finished.

[Step SA14] It is determined whether or not the auxiliary command completion signal is on and the auxiliary command signal is off. If the auxiliary command completion signal is on and the auxiliary command signal is off (YES), the process proceeds to step SA15. Otherwise (NO), the process is finished.

[Step SA15] The auxiliary command completion signal is turned off, and the process is finished.

FIG. 13 is a time chart showing the relationship between output of an M-code number and the signals.

The above manipulation of a video camera by using M-codes suffers from the problems below.

(1) Since one manipulation corresponds to one M-code, it is impossible to add many commands for, e.g., starting/stopping of image pickup, selection of a video camera, and designation of resolution, image type, and the number of frames per unit time, to one M-code command and pass the M-code command to a ladder sequence. For this reason, as shown in FIG. 10, M-codes and a ladder sequence corresponding to the number of the types of manipulations of a video camera need to be prepared. As a result, as shown in the flow chart in FIG. 12, the number of M-codes is large, commands of a machining program are complicated, and development of a corresponding ladder sequence is necessary.
(2) If a plurality of video cameras are attached to one machine tool to monitor different locations inside the machine tool, different sets of M-codes and different ladder sequences need to be prepared for the video cameras, as shown in FIGS. 10 and 12.

(3) Since handshaking is performed between a ladder sequence and a numerical controller in the case of M-codes, cycle time is long, as shown in FIG. 13.

(4) As sets of M-codes differ from one machine tool to another, a machining program including manipulation of a video camera cannot be used for a different machine tool.

As for the ladder sequence problems in (1) and (2) among the above problems, Japanese Patent Application Laid-Open No. 2012-18511 discloses a technique for reducing processing in the sequence processing section by allowing switching of whether an auxiliary command issued by a machining program is to be processed by the sequence processing section or the built-in auxiliary command processing section, on the basis of settings in the switching setting section.

However, since the technique performs one process by using one M-code, the number of M-codes used for processing cannot be reduced.

As for the handshaking problem in (3) among the above problems, Japanese Patent Application Laid-Open No. 63-205707 discloses the technique for shortening processing time by completing a handshaking procedure only by the PMC outputting a process completion signal. Since even if the technique is used, handshaking using M-code commands remains present, processing time cannot be greatly shortened.

### SUMMARY OF THE INVENTION

The object of the present invention is to provide a numerical controller having a function of manipulating a video camera which can easily give a manipulation command, can shorten processing time, and can be commonly used for different machine tools.

A numerical controller according to the present invention has a function of manipulating a video camera by using a G-code command, and a video camera which shoots a machine tool controlled by the numerical controller is connected to the numerical controller. The numerical controller includes a command section which commands image pickup by the video camera or stopping of the image pickup by using a G-code of the numerical controller and an execution section which executes image pickup by the video camera or stopping of the image pickup when a command is given by the command section.

According to the numerical controller, a manipulation command for, e.g., starting/stopping image pickup to a video camera can be given by using a G-code, and a manipulation command can be more easily given than a conventional manipulation command using an M-code. Additionally, since a command with a plurality of words can be given in one code, a command to a video camera can be given in one block. Unlike an M-code based command, many codes need not be used to give a command to one video camera. In addition, a G-code based command does not require handshaking, and cycle time can be made shorter than in the case of a command using an M-code. Moreover, although sets of M-codes may differ from one machine tool to another, G-codes are commonly used in same numerical controllers. Even different machine tools can commonly use G-codes as long as the machine tools use same inside numerical controllers.

A command using the G-code can include one of selection of a video camera to perform image pickup, a command for image pickup or stopping of the image pickup, designation of resolution, designation of image type, and designation of the number of frames.

In this embodiment, various operations of a video camera can be performed by commands using the G-code.

The numerical controller reads a G-code command to the video camera from a machining program described in macro statements, and if the read G-code command is a command for image pickup by the video camera or stopping of the image pickup, the execution section may execute image pickup by the video camera or stopping of the image pickup.

In this embodiment, if a command for commanding video camera manipulation is found through command analysis processing when a macro statement in a machining program is read, a process of executing the video camera manipulation command can be performed.

The numerical controller stores a specific range which commands operation by the video camera in a machining program, and if a command using the G-code to the video camera is read from the specific range of the machining program when the stored specific range is invoked during execution of the machining program, and the specific range is executed in parallel with the machining program being executed, the execution section may execute image pickup by the video camera or stopping of the image pickup simultaneously with the execution of the machining program being executed.

In this embodiment, by temporarily storing a command related to the video camera, image pickup by a video camera or stopping of image pickup that is stored in advance can be executed in parallel simultaneously with execution of another machining program.

The present invention includes the above-described features and thus can achieve the effects below.

(1) In a machining program, a manipulation command for, e.g., starting/stopping image pickup to a video camera can be easily given by using a G-code.
(2) Since a command with a plurality of words can be given in one G-code, a command to a video camera can be given in one block.
(3) Since handshaking is unnecessary, cycle time can be made shorter than in the case of a command using an M-code.
(4) Unlike sets of M-codes which differ from one machine tool to another, G-codes are common among numerical controllers of a kind. Even different machine tools can be commonly used as long as the machine tools are equipped with same numerical controllers.

### BRIEF DESCRIPTION OF THE DRAWINGS

The foregoing and other objects and features of the present invention will become more apparent from the following description of an embodiment thereof, taken in conjunction with the accompanying drawings. In the drawings:

FIG. 1 is a configuration diagram of a numerical controller having a function of manipulating a video camera by using G-code commands, according to the present invention, and peripheral devices;

FIG. 2 is a diagram showing the internal configuration of the numerical controller in FIG. 1 and how a first video camera and a second video camera are connected to the numerical controller;

FIG. 3 is a chart showing interface setting in the numerical controller in FIG. 1 when the video cameras are connected to the numerical controller;

FIG. 4 is a flow chart showing a process flow of machining program command analysis execution by the numerical controller in FIG. 1;

FIG. 5 is a chart showing an example of a G-code based command format;

FIG. 6 is a flow chart showing a detailed flow of a one-shot G-code preparatory function process during the machining program command analysis execution by the numerical controller in FIG. 1;

FIG. 7 is a chart for explaining a command example when NC statements are used in a machining program in the process flow of the machining program command analysis execution in FIG. 4;

FIG. 8 is a chart for explaining a command example when macro statements are used in a machining program in the process flow of the machining program command analysis execution in FIG. 4;

FIG. 9 is a chart for explaining an example of a machining program when parallel execution processing is performed;

FIG. 10 is a chart showing the correspondence between M-code commands and manipulation command contents;

FIG. 11 is a view showing an example of a machining program using M-code commands;

FIG. 12 is a flow chart showing a flow of manipulation of a video camera by using M-code commands; and

FIG. 13 is a time chart showing the relationship between output of an M-code number and signals.

### DETAILED DESCRIPTION OF THE PREFERRED EMBODIMENT

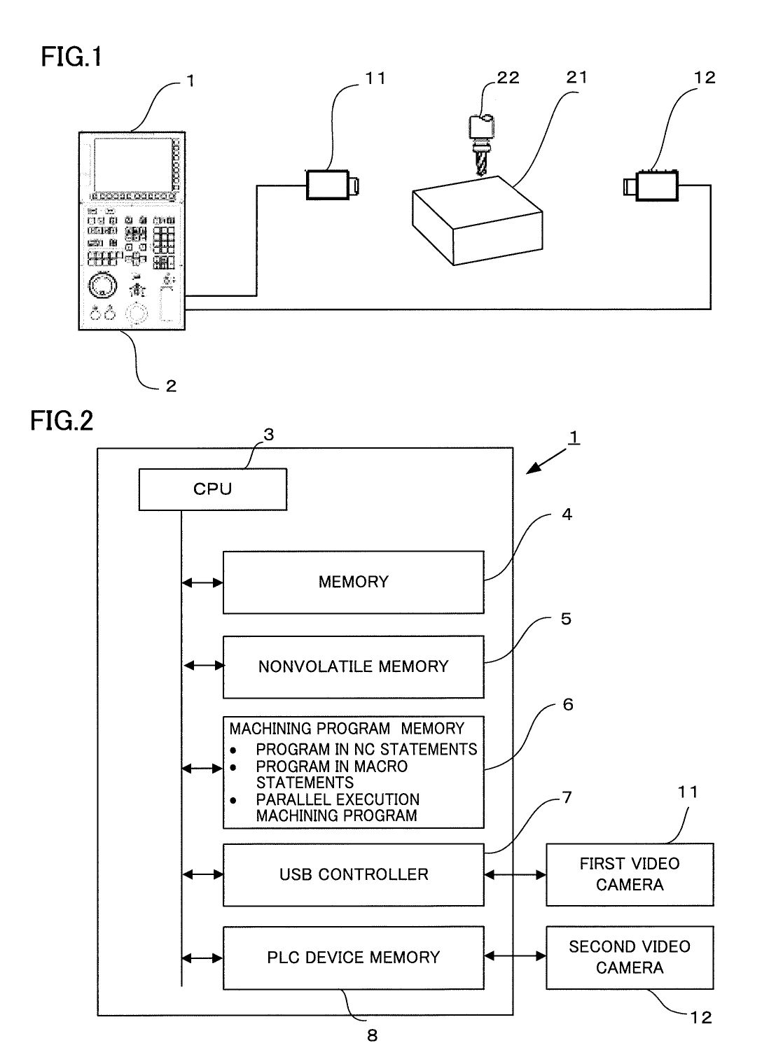

The configuration of a numerical controller having a function of manipulating a video camera by using G-code commands, according to the present invention, and peripheral devices will be described with reference to FIG. 1.

A machine control panel 2 for manipulating and setting up various machines is provided at a numerical controller 1. A first video camera 11 and a second video camera 12 are connected to the numerical controller 1. The first video camera 11 and second video camera 12 are installed at different locations inside a machine tool and pick up images of a workpiece 21 to be machined and a tool 22 which is mounted to a spindle device.

The internal configuration of the numerical controller 1 and how the numerical controller 1 and the first video camera 11 and second video camera 12 are connected will be described with reference to FIG. 2.

The numerical controller 1 includes a CPU 3, a memory 4, a nonvolatile memory 5, a machining program memory 6, a USB controller 7, and a PLC device memory 8. A program in NC statements, a program in macro statements, a program for parallel execution machining, or the like for giving a command to manipulate a video camera is stored in the machining program memory 6. The first video camera 11 is connected by USB to the USB controller 7 while the second video camera 12 is connected as a PLC device to the PLC device memory 8.

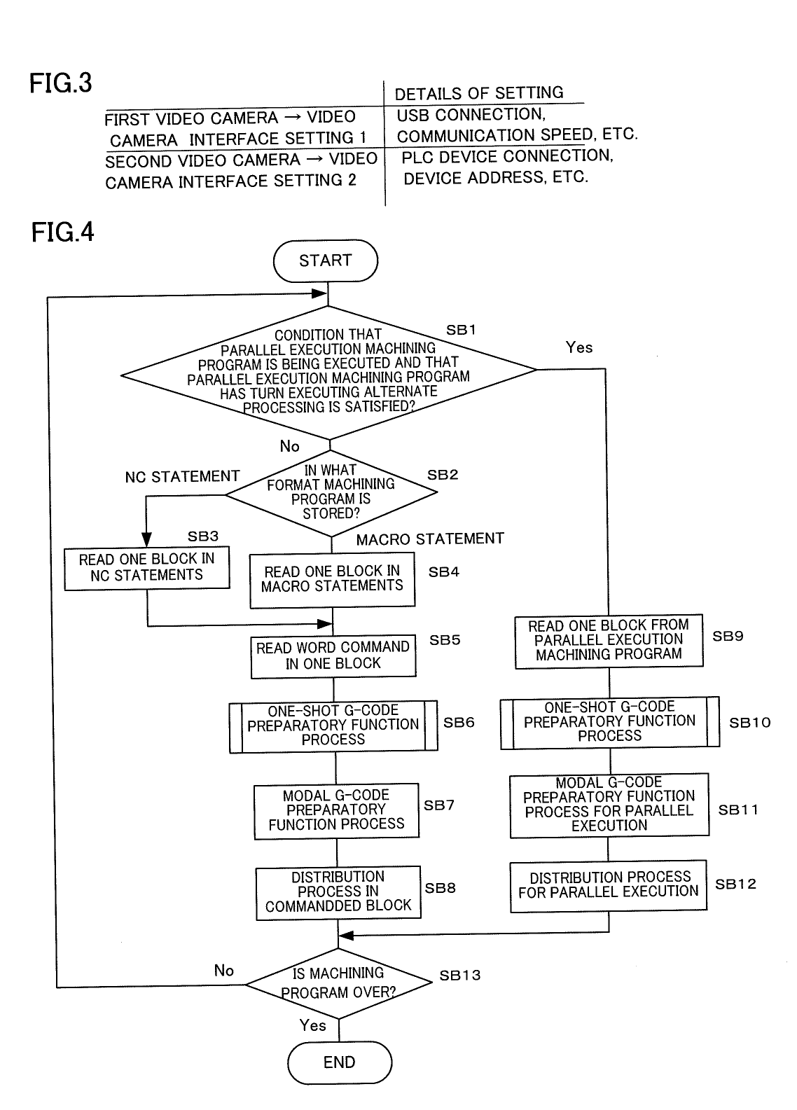

Interface setting in the numerical controller 1 when a video camera is connected to the numerical controller 1 will be described with reference to FIG. 3.

According to FIG. 3, the first video camera 11 is connected by USB to the numerical controller 1, and the second video camera 12 is connected as a PLC device, as shown in FIG. 2. At the time of video camera connection, the details of video camera interface setting in the numerical controller 1 are determined according to a connection site, properties of a video camera to be connected, and the like.

In video camera interface setting 1 in the numerical controller 1, connection of the first video camera 11 to be connected by USB and the communication speed of the camera are set. In video camera interface setting 2 in the numerical controller 1, connection of the second video camera 12 to be connected as a PLC device and the address of a device memory are set.

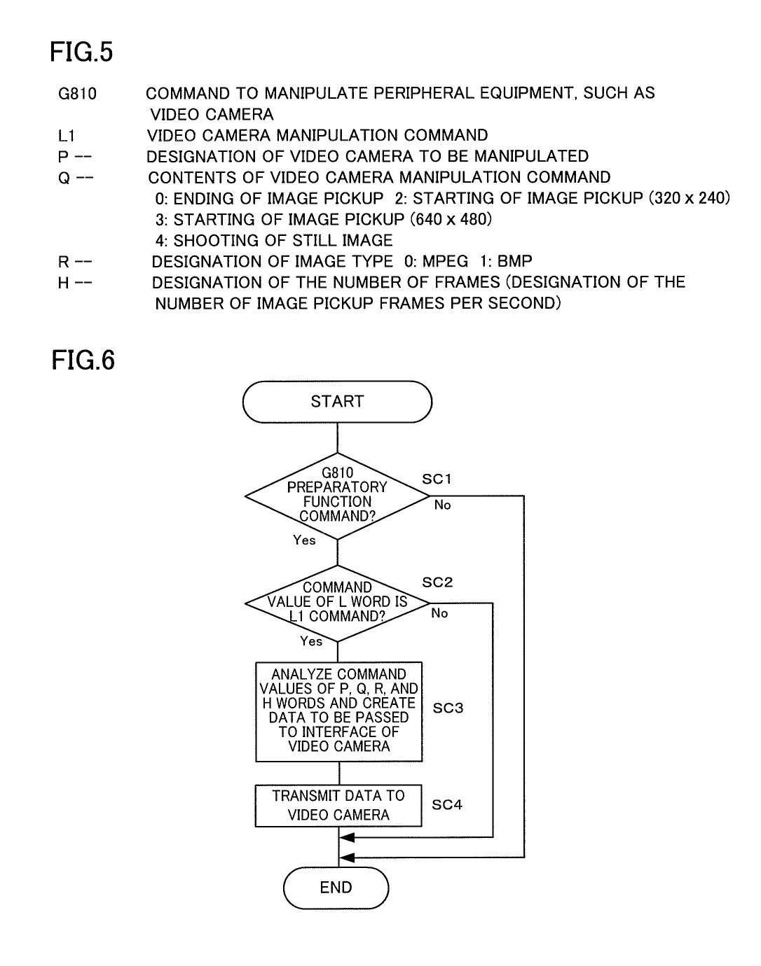

A process of machining program command analysis execution by the numerical controller 1 will be described with reference to the flow chart in FIG. 4. Steps of the flow chart will be described below.

[Step SB1] It is first determined whether or not a parallel execution machining program is being executed and the parallel execution machining program has a turn to be executed which is determined by program switching process. If the result of the determination is YES, the process proceeds to step SB9. On the other hand, if the result is NO, the process proceeds to step SB2.
[Step SB2] It is determined whether the machining program stored in the numerical controller 1 is stored in NC statements or not. If the machining program is stored in NC statements, the process proceeds to step SB3. On the other hand, if the machining program is not stored in NC statements (is stored in macro statements), the process proceeds to step SB4.
[Step SB3] One block is read in NC statements.
[Step SB4] One block is read in macro statements.
[Step SB5] A word command among commands in the one block that is read in NC statements or in macro statements is read.
[Step SB6] A one-shot G-code preparatory function process is performed. The details of the process will be described later with reference to FIG. 6.
[Step SB7] A modal G-code preparatory function process, typified by a command for interpolation, such as linear interpolation or circular interpolation, or coordinate system selection, is performed.
[Step SB8] A process of distributing movement pulses to respective axes in one commanded block is performed, and the process proceeds to step SB13.
[Step SB9] One block is read from the parallel execution machining program.
[Step SB10] The one-shot G-code preparatory function process is performed. The details of the process will be described later with reference to FIG. 6.
[Step SB11] A modal G-code preparatory function process for parallel execution is performed.
[Step SB12] A process of distributing movement pulses to the respective axes in one parallel-execution commanded block is performed, and the process proceeds to step SB13.
[Step SB13] It is determined whether the machining program is over or not. If the machining program is over (YES), the process (the process of machining program command analysis execution) is finished. On the other hand, if the machining program is not over (NO), the flow returns to step SB1 to repeat the process.

An example of a G-code based command format is shown in FIG. 5.

G810 is a code indicating a command to manipulate peripheral equipments, such as a video camera. Although G810 is used as a code commanding manipulation of a video camera or the like in the present embodiment, G810 is illustrative only and is not intended to be limiting. Any other G-code may be used. L, P, Q, R, and H below G810 are word commands. If the L word command is L1, G810 serves as a video camera manipulation command. In the P word command, a video camera to be manipulated is designated. The Q word command indicates the contents of the command to manipulate the video camera. Q0 indicates ending of image pickup, Q2 indicates starting of image pickup at a resolution of 320×240 by the video camera, Q3 indicates starting of image pickup at a resolution of 640×480 by the video camera, and Q4 indicates shooting of a still image. In the R word command, image type is designated. R0 indicates MPEG format, and R1 indicates BMP format. In the H word command, the number of frames, i.e., the number of image pickup frames per second is designated. The word commands are illustrative only and are not intended to be limiting.

The details of the one-shot G-code preparatory function process in step SB6 and step SB10 of the process flow of the machining program command analysis execution shown in FIG. 4 will be described with reference to the flow chart in FIG. 6. Steps of the flow chart will be described below.

[Step SC1] It is first determined whether or not there is a command related to a G810 preparatory function for a video camera manipulation command as a preparatory function of the numerical controller 1. If there is the command (YES), the process proceeds to step SC2. On the other hand, if there is not the command (NO), the process is finished.
[Step SC2] It is determined whether or not there is an L word which is a video camera manipulation command in the G-code command. If there is an L word (YES), the process proceeds to step SC3. On the other hand, if there is no L word (NO), the process is finished.
[Step SC3] Command values of a P word which designates a video camera to be manipulated, a Q word which indicates the contents of the command to manipulate the video camera, an R word which designates image type, and an H word which designates the number of frames are analyzed, and data to be passed to an interface of the video camera is created, and then the process proceeds to step SC4.
[Step SC4] The data created in step SC3 is transmitted to the video camera, and the process (the one-shot G-code preparatory function process) is finished.

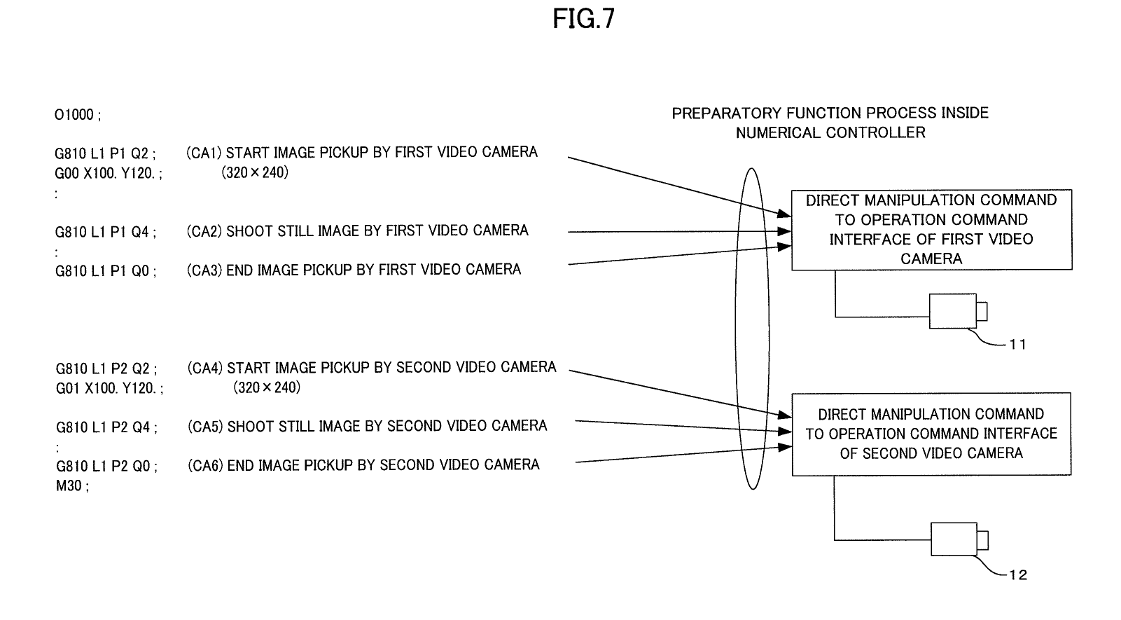

An example of commands when an NC statement is used to describe a machining program in the process flow of the machining program command analysis execution shown in FIG. 4 will be described with reference to FIG. 7.

Commands denoted by CA1 to CA3 are commands related to the first video camera. When the commands are issued, preparatory function processes are sequentially performed in the numerical controller 1, and respective manipulation commands are directly given to an operation command interface of the first video camera. Similarly, commands denoted by CA4 to CA6 are commands related to the second video camera. When the commands are issued, preparatory function processes are sequentially performed in the numerical controller 1, and respective manipulation commands are directly given to an operation command interface of the second video camera.

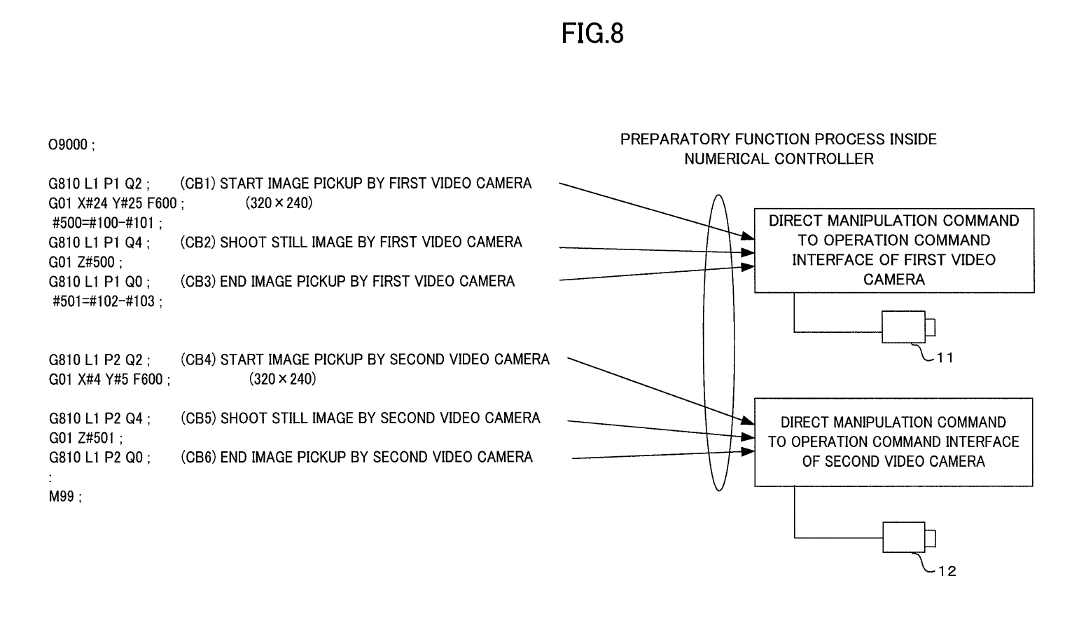

An example of commands when a macro statement is used to describe a machining program in the process flow of the machining program command analysis execution shown in FIG. 4 will be described with reference to FIG. 8.

The example in FIG. 8 is the same as the example in FIG. 7 except that the program is described in a different format, i.e., in macro statements. That is, commands denoted by CB1 to CB3 are commands related to the first video camera. When the commands are issued, the preparatory function processes are sequentially performed in the numerical controller 1, and the respective manipulation commands are directly given to the operation command interface of the first video camera. Similarly, commands denoted by CB4 to CB6 are commands related to the second video camera. When the commands are issued, the preparatory function processes are sequentially performed in the numerical controller 1, and the respective manipulation commands are directly given to the operation command interface of the second video camera.

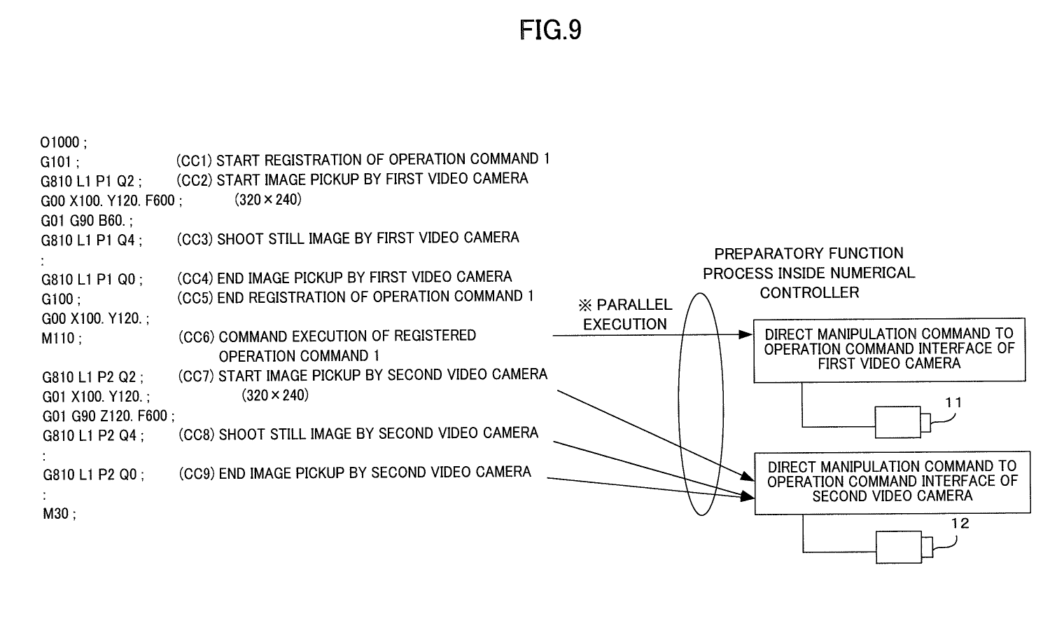

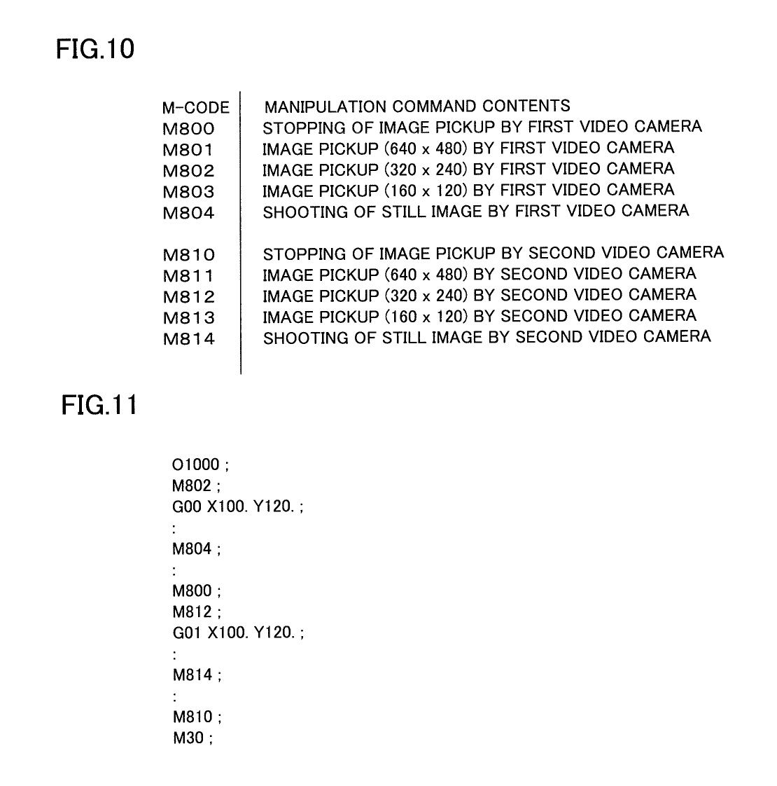

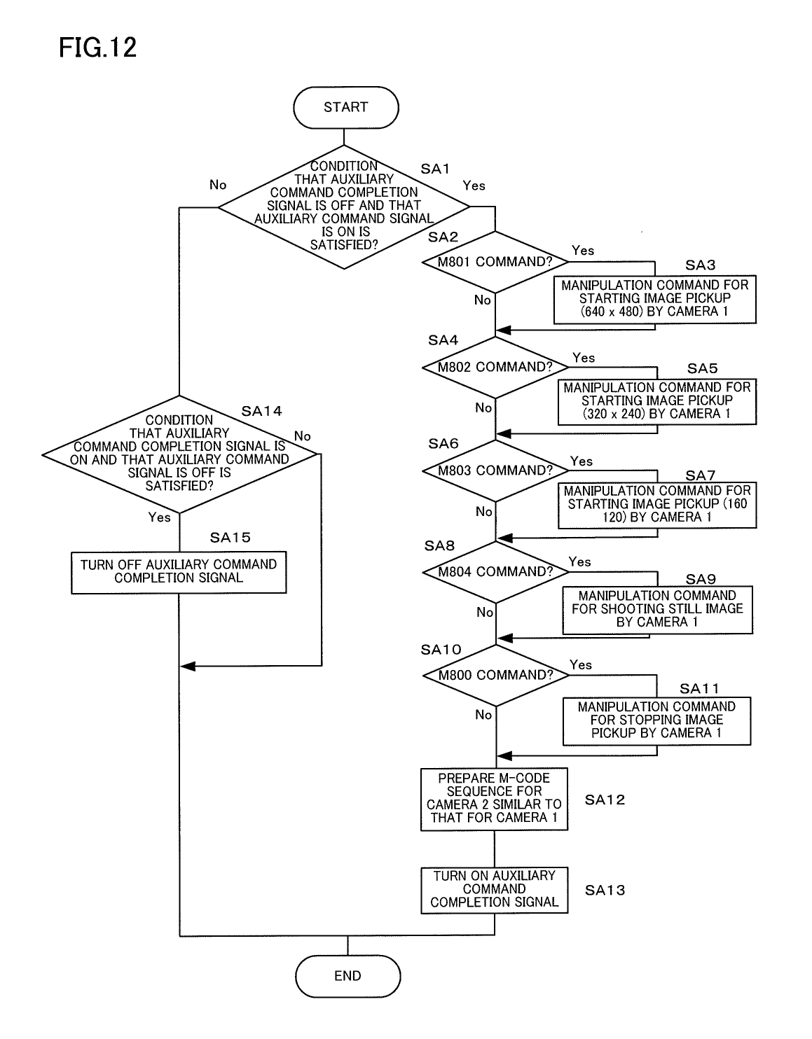

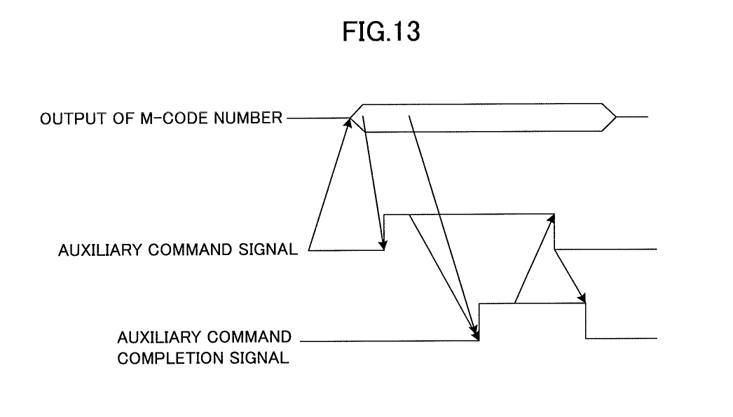

An example of a machining program when parallel execution process is performed will be described with reference to FIG. 9. Note that although NC statements are used to describe a machining program in the example shown in FIG. 9, parallel execution processing can also be performed by using a macro statement, instead of a NC statement.

Registration of a parallel execution operation command as operation command 1 is started by a command denoted by CC1. Commands in a block next to CC1 to a block previous to CC5 (commands denoted by CC2 to CC4) before the registration of operation command 1 is finished by a command denoted by CC5 are registered as operation command 1. Registered operation command 1 is executed by a command denoted by CC6, and G-code commands denoted by CC7 to CC9 related to the second video camera are executed in parallel with operation command 1.

In the one embodiment of the present invention, a “specific range” of a machining program which commands operation by a video camera in the machining program is stored in advance, and if a command based on the G-codes to the video camera is read from the specific range of the machining program when the stored “specific range” is invoked during execution of the machining program and the invoked “specific range” is executed in parallel with the machining program being executed, image pickup by the video camera or stopping of the image pickup is carried out simultaneously with the execution of the machining program being executed. In this case, the “specific range” corresponds to CC1 to CC5 in the example in FIG. 9.

Note that although a command to the first video camera is registered in advance as operation command 1, and the command is executed in parallel with processing executed for the second video camera in the present embodiment, the present invention is not limited to this. A command to the second video camera may be registered. An operation registered as an operation command can also be executed in parallel with a process of commands other than a command to a video camera.

What is claimed is:

1. A numerical controller having a function of manipulating a video camera by using a G-code command, a video camera which shoots a machine tool controlled by the numerical controller being connected to the numerical controller, comprising:
a command section which commands image pickup by the video camera or stopping of the image pickup by using a G-code of the numerical controller; and
an execution section which executes image pickup by the video camera or stopping of the image pickup when a command is given by the command section.

2. The numerical controller having the function of manipulating a video camera by using a G-code command, according to claim 1, wherein a command using the G-code includes one of selection of a video camera to perform image pickup, a command for image pickup or stopping of the image pickup, designation of resolution, designation of image type, and designation of the number of frames.

3. The numerical controller having the function of manipulating a video camera by using a G-code command, according to claim 1, wherein
the numerical controller reads a G-code command to the video camera from a machining program described in macro statements, and
if the read G-code command is a command for image pickup by the video camera or stopping of the image pickup, the execution section executes image pickup by the video camera or stopping of the image pickup.

4. The numerical controller having the function of manipulating a video camera by using a G-code command, according to claim 1, wherein
the numerical controller stores a specific range which commands operation by the video camera in a machining program, and
if a command using the G-code to the video camera is read from the specific range of the machining program when the stored specific range is invoked during execution of the machining program and the specific range is executed in parallel with the machining program being executed, the execution section executes image pickup by the video camera or stopping of the image pickup simultaneously with the execution of the machining program being executed.
